(19) United States
(12) Patent Application Publication
(10) Pub. No.: US 2024/0359948 A1
(43) Pub. Date: Oct. 31, 2024

(54) MODULAR LIFTING APPARATUS AND LIFTING SYSTEM

(71) Applicant: FICONT INDUSTRY (BEIJING) CO., LTD., Beijing (CN)

(72) Inventors: Tiehui YU, Beijing (CN); Ming HE, Beijing (CN); Jiwei WANG, Beijing (CN)

(21) Appl. No.: 18/573,986

(22) PCT Filed: Jul. 25, 2022
(86) PCT No.: PCT/CN2022/107656

§ 371 Date: Dec. 22, 2023

(30) Foreign Application Priority Data
Sep. 24, 2021 (CN) 202111123418.8

(51) Int. Cl. B66B 9/02; B66B 11/02; B66B 11/04; E06C 7/12

(52) U.S. Cl. CPC B66B 9/022; B66B 11/0226; B66B 11/0461; E06C 7/12

(57) ABSTRACT

A modular lifting apparatus includes a vehicle body assembly and a drive control assembly. The vehicle body assembly includes a vehicle body and a pedal component, and the pedal component is connected to the vehicle body. The drive control assembly is disposed on the vehicle body, and includes a control component, a drive component and an auxiliary guide component. The control component is connected to the drive component. The drive component and the auxiliary guide component are used to cooperate with a guide body to allow the vehicle body to move in an extension direction of the guide body.

### CROSS-REFERENCE TO RELATED APPLICATIONS

The present application claims the priority of the Chinese patent application No. 202111123418.8 filed on Sep. 24, 2021, and entitled “MODULAR LIFTING APPARATUS AND LIFTING SYSTEM”, which is incorporated herein in its entirety by reference.

### FIELD OF TECHNOLOGY

The present application belongs to the technical field of climbing devices, and particularly relates to a modular lifting apparatus and a lifting system.

### BACKGROUND

In recent years, with the continuous development of aerial lifting apparatuses, the development of climbing products with simple structure, easy installation, reliable functions and low cost has become the direction of enterprise development.

At present, there are a variety of climbing apparatuses such as a non-climbing device on the market, which may operate up and down along a track mounted on a building or an equipment ladder for overhead operations of transporting personnel and supplies.

However, existing climbing apparatuses have some common defects, that is, the structure is complex, the degree of centralization is low, there are multiple mounting steps, dismantling and installation are trouble, and the operating time is long.

### SUMMARY

The present application aims to provide a modular lifting apparatus and a lifting system.

In a first aspect, some embodiments of the present application provide a modular lifting apparatus.

The modular lifting apparatus includes:

a vehicle body assembly, including a vehicle body and a pedal component, the pedal component being connected to the vehicle body; and

a drive control assembly, disposed on the vehicle body and including a control component, a drive component and an auxiliary guide component, the control component being connected to the drive component, wherein the drive component and the auxiliary guide component are used for cooperating with a guide body to allow the vehicle body to move in an extension direction of the guide body.

In a second aspect, some embodiments of the present application provide a lifting system. The lifting system includes a guide body and the modular lifting apparatus according to any one of the above, the guide body being attached to a surface of a building or a surface of a tower.

### BRIEF DESCRIPTION OF THE DRAWINGS

The foregoing and/or additional aspects and advantages of the present application will become apparent and readily appreciated from the following description of the embodiments, taken in conjunction with the accompanying drawings.

FIG. 1 is a schematic diagram of a use state of a modular lifting apparatus according to embodiments of the present application.

FIG. 2 is a three-dimensional schematic diagram of a drive control assembly in a first modular lifting apparatus according to embodiments of the present application.

FIG. 3 is a schematic rear view of FIG. 2 according to embodiments of the present application.

FIG. 4 is a schematic diagram of a state in which a drive cover of a drive control assembly in FIG. 2 is open, according to embodiments of the present application.

FIG. 5 is an enlarged view of a portion A in FIG. 4 according to embodiments of the present application.

FIG. 6 is a three-dimensional schematic diagram of a vehicle body assembly (not including a box) in a first modular lifting apparatus according to embodiments of the present application.

FIG. 7 is a schematic rear view of FIG. 6 according to embodiments of the present application.

FIG. 8 is a three-dimensional schematic view of a drive control assembly in a second modular lifting apparatus according to the present application.

FIG. 9 is a first schematic structural diagram of a third modular lifting apparatus according to the present application.

FIG. 10 is a second schematic structural diagram of a third modular lifting apparatus according to embodiments of the present application.

FIG. 11 is a first schematic structural diagram of a fourth modular lifting apparatus according to embodiments of the present application.

FIG. 12 is a second schematic structural diagram of a fourth modular lifting apparatus according to embodiments of the present application.

FIG. 13 is a third schematic structural diagram of a fourth modular lifting apparatus according to embodiments of the present application.

FIG. 14 is a schematic structural diagram of a lifting system according to embodiments of the present application.

### Reference Numerals

10. Vehicle body assembly; 11. Vehicle body; 1101. Base plate;
1102. Box; 101. First chamber; 102. Second chamber;
1121. Structural frame; 1122. Box plate; 1131. First spacer;
1132. Second spacer; 1103. Mounting platform; 1111. Positioning hole;
112. Through hole; 113. Stall protection device; 114. Fastener;
115. Supporting wheel; 12. Pedal component; 121. Stepping portion;
122. Mounting portion; 13. Auxiliary guide component; 131. Guide wheel;
132. Bias guide wheel; 133. Adjusting member; 134. Guide hook wheel;
141. First mounting hole; 142. Second mounting hole; 151. Eccentric shaft;
20. Drive control assembly; 21. Control component; 211. Emergency stop switch;
212. Gear changeover switch; 213. Control module; 22. Drive component;
221. Rotary drive member; 222. Drive gear; 23. Handrail component;
231. First handle; 232. Second handle; 233. Platform trigger structure;
234. Handrail bar; 24. Auxiliary stepping member; 241. Auxiliary plate;
242. Mounting seat; 25. Positioning pin; 26. Caster;
27. Trigger switch; 28. Buzzer; 29. Drive cover;
230. Control cover; 240. Power supply module; 250. Antenna;
30. Guide body; 31. Base guide rail; 32. Fall prevention guide rail;
321. Fall prevention hole; 33. Trigger limiting mechanism; and 34. Mechanical limiting mechanism.

### DESCRIPTION OF THE EMBODIMENTS

The embodiments of the present application will be described below in detail, examples of which are illustrated in the accompanying drawings. The same or similar reference numerals refer to the same or similar elements or elements having the same or similar functions throughout. The embodiments described below with reference to the accompanying drawings are exemplary, and are merely used to be illustrative of the present application and should not be construed as limiting the present application. Based on the embodiments of the present application, all other embodiments obtained by a person of ordinary skill in the art without any creative effort fall within the protection scope of the present application.

In the description of the present application, it is to be noted that, unless otherwise expressly specified and limited, the term “connected” should be understood in a broad sense, for example, it may be a fixed connection, a detachable connection, or an integral connection; or it may be a mechanical connection or an electrical connection; or it may be a direct connection or an indirect connection through an intermediate medium; or it may be the communication between two elements. For a person of ordinary skill in the art, the specific meaning of the above-mentioned terms in the present application may be understood according to specific situations.

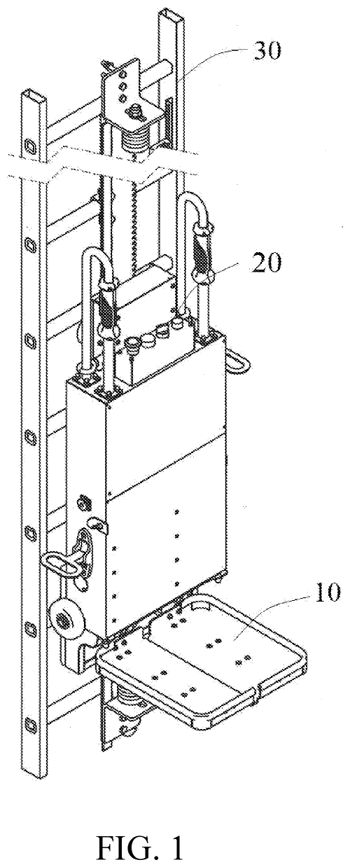

Referring to FIG. 1 to FIG. 14, a modular lifting apparatus and a lifting system set forth by embodiments of the present application are illustrated. It should be understood that the following description is only a schematic implementation of the present application and does not constitute any limitation of the present application.

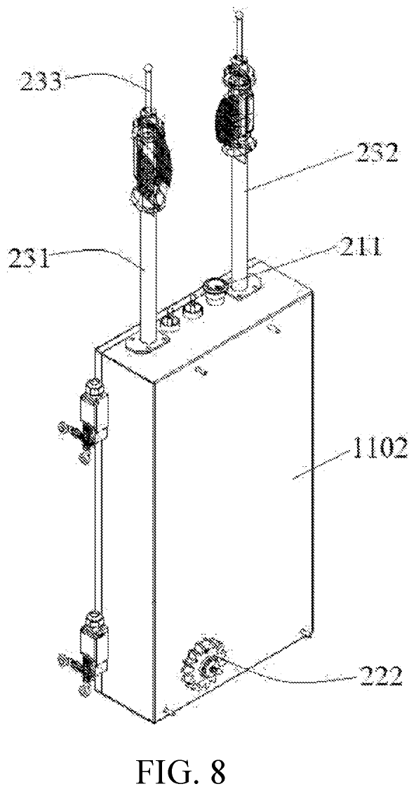

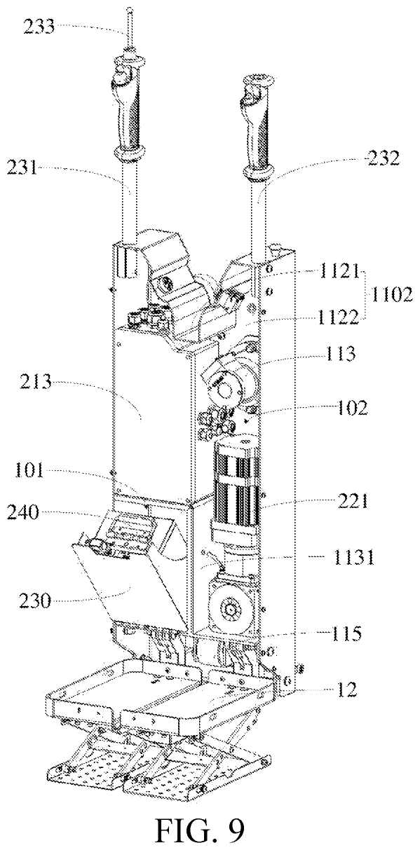

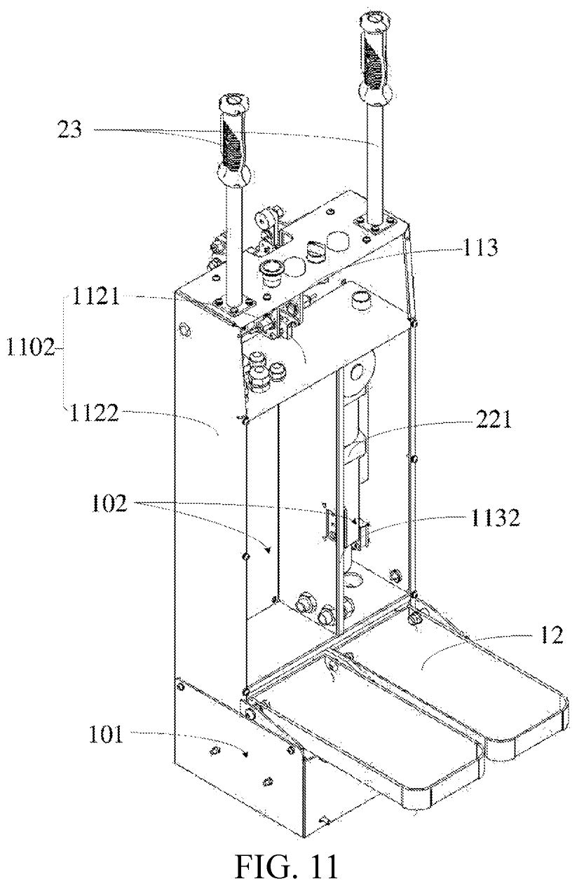

Referring to FIG. 1, FIG. 8, FIG. 9, and FIG. 11, an embodiment of the present application provides a modular lifting apparatus. The modular lifting apparatus is applied to a building or an equipment ladder, and is capable of operating up and down along a track mounted on the building or the equipment ladder to carry out overhead operations of transporting personnel and materials.

The modular lifting apparatus includes a vehicle body assembly 10 and a drive control assembly 20. The vehicle body assembly 10 includes a vehicle body 11 and a pedal component 12, and the pedal component 12 is connected to the vehicle body 11. The pedal component 12 is used for stepping by an operator. The pedal component 12 may be either removably connected to the vehicle body 11 by means of a bolt locking component or rotationally connected to the vehicle body 11 by means of an articulated member, but at least it should be ensured that in an operating state, a stepping surface of the pedal component 12 is perpendicular to a surface of the vehicle body 11.

Further, the drive control assembly 20 is disposed on the vehicle body 11, the drive control assembly 20 includes a control component 21, a drive component 22 and an auxiliary guide component 13, and the control component 21 is connected to the drive component 22.

The drive component 22 and the auxiliary guide component 13 are used for cooperating with a guide body 30 to allow the vehicle body 11 to move in an extension direction of the guide body 30. In practical application, the aforementioned guide body 30 is usually provided as a vertically arranged guide rail, and an output end of the drive component 22 is in power coupled connection with the guide body 30. The control component 21 is used for sending a control instruction to the drive component 22 to control an operation state of the drive component 22, so that on the basis of a driving force provided by the drive component 22, the vehicle body 11 may ascend or descend along the guide body 30 under the cooperation between the drive component 22 and the guide body 30.

At the same time, on the basis of the cooperation between the auxiliary guide component 13 and the guide body 30, both the reliability of the connection between the drive component 22 and the guide body 30 and the stability of ascending or descending of the vehicle body 11 with respect to the guide body 30 are ensured, thereby preventing the modular lifting apparatus from being separated from the guide body 30.

As can be seen from the above, the present application adopts a modular design, integrates the vehicle body 11 and the pedal component 12 into the modular vehicle body assembly 10, and integrates the drive control assembly 20 into the vehicle body 11, which not only ensures the compactness of the overall structure of the lifting apparatus and reduces the occupied space, but also achieves rapid dismantling and installation of the lifting apparatus in the engineering site and ensures the safety and reliability of ascending or descending of the modular lifting apparatus, thereby being widely applicable to climbing operations in the fields of wind power and electric pylons.

The modular lifting apparatus of the present application is specifically described below in conjunction with specific embodiments.

In some embodiments of the present application, referring to FIG. 1 to FIG. 7, in the modular lifting apparatus in the embodiment of the present application, the vehicle body 11 includes a base plate 1101 and a box 1102. The pedal component 12 and the box 1102 are each removably connected to the base plate 1101. The drive control assembly 20 is mounted in the box 1102, and a portion of the drive control assembly 20 extends out of the box 1102 and cooperates with the guide body 30.

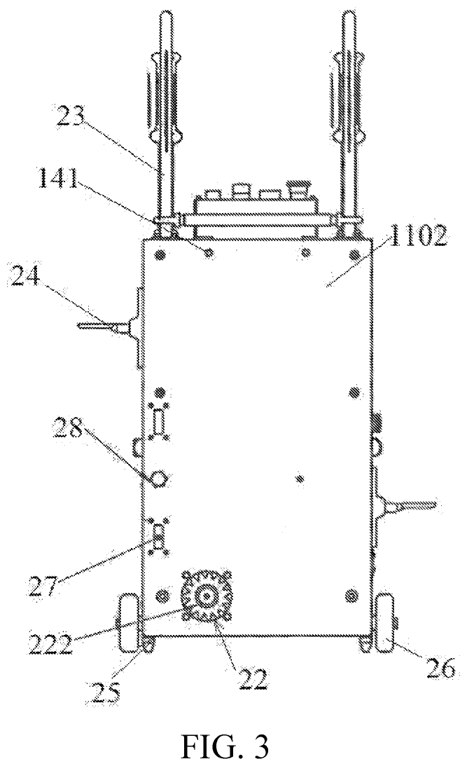

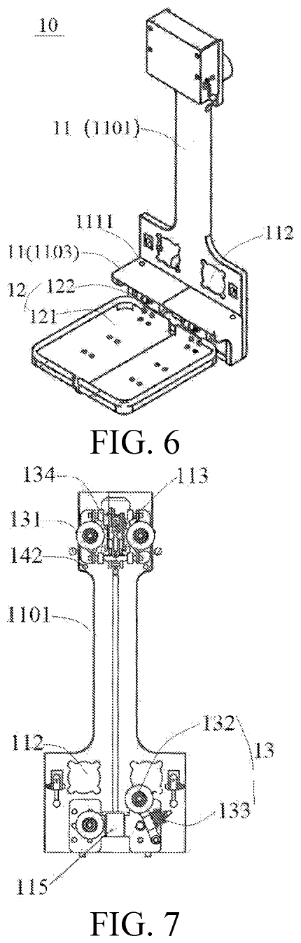

As shown in FIG. 1 and FIG. 6, the box 1102 is mounted on a side of the base plate 1101 facing away from the guide body 30, and the base plate 1101 may be in an “I” shape, which may not only meet the rigidity support requirements of the base plate 1101, but also save processing materials and reduce the weight of the base plate 1101. The shape of the base plate 1101 is not specifically limited, and is only exemplified herein. The base plate 1101 may also be in other shapes, such as a rectangular structure. As shown in FIG. 3 and FIG. 4, the drive component 22 serves as a part of the drive control assembly 20, and the drive component 22 includes a rotary drive member 221 and a drive gear 222. The rotary drive member 221 may be a gear motor known in the art, or the rotary drive member 221 may also be a drive structure formed by a servomotor and a worm gear structure. The rotary drive member 221 is disposed in the box 1102, an output end of the rotary drive member 221 penetrates through the box 1102 and the base plate 1101 in sequence and is connected to the drive gear 222, and the drive gear 222 is engaged with the guide body 30.

A mounting space for mounting the drive component 22 and the control component 21 is defined by the box 1102, thereby achieving an effect of protecting the drive component 22 and the control component 21.

As shown in FIG. 3, the drive gear 222 of the drive component 22 extends to an outer side of the box 1102, and a through hole 112 for the drive gear 222 to pass through is provided in the base plate 1101. As shown in FIG. 7, the drive gear 222 may pass through the through hole 112 and be engaged with the guide body 30 to form a power output structure.

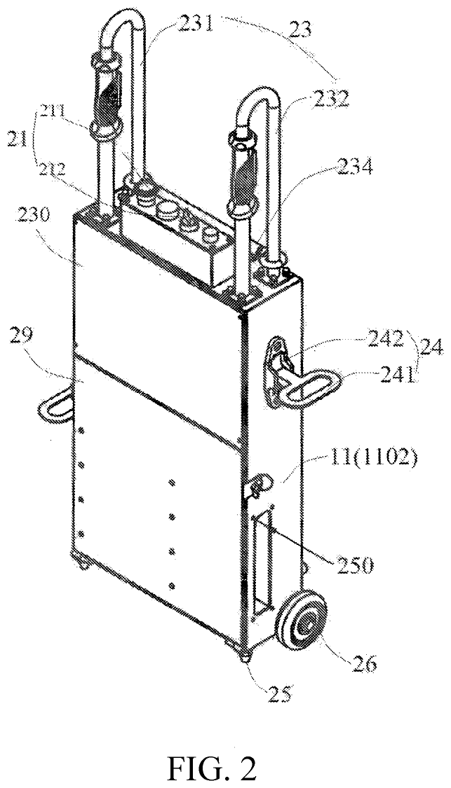

As shown in FIG. 2 to FIG. 4, casters 26 are mounted at a bottom of the box 1102. When the box 1102 is removed from the base plate 1101 and needs to be replaced or mounted on another base plate 1101, the box 1102 may be conveniently moved by means of the casters 26, thereby ensuring that time and effort are saved during mounting.

As shown in FIG. 2, in this embodiment, the control component 21 includes a control switch, the control switch is used for controlling the modular lifting apparatus to perform upward movement, downward movement, and decelerated operation on the guide body 30, or the control switch is used for switching an operation control mode of the modular lifting apparatus to a remote control mode, or the control switch is used for performing an emergency stop control over the modular lifting apparatus and sending a control instruction to an electromagnetic brake in an emergency situation, so as to control the electromagnetic brake to perform a braking action on an output shaft of the rotary drive member 221, thereby achieving braking control over the modular lifting apparatus.

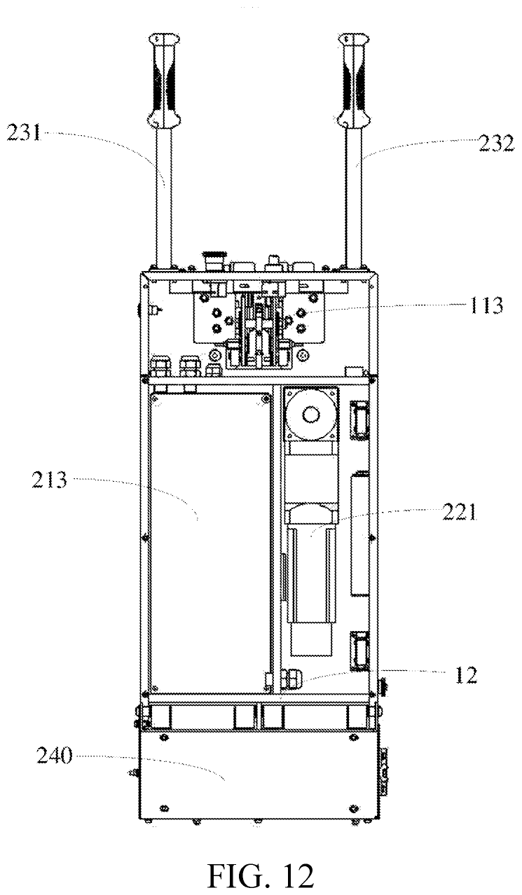

Further, the control component 21 in this embodiment includes a control module 213, the control switch is connected to the control module 213, and the control module 213 is connected to the drive component 22 and the aforementioned electromagnetic brake. The control module 213 is specifically illustrated in FIG. 9 and FIG. 12.

The control module 213 is disposed within the box 1102, and the control switch is disposed outside the box 1102. For example, the control switch is disposed on a top of the box 1102, or the control switch may be disposed on a handrail component 23 in an embedded manner, which depends on the environment of use.

In some examples, as shown in FIG. 2, the control switch includes an emergency stop switch 211 and a gear changeover switch 212. The gear changeover switch 212 is provided with three gears to control changeover of the upward movement, downward movement, and remote control mode of the modular lifting apparatus, respectively. In addition, other buttons and indicator lights may be disposed at the mounting position of the control switch.

Specifically, controlling the upward and downward movement of the lifting apparatus by the gear changeover switch 212 is equivalent to controlling forward and reverse rotation of the rotary drive member 221 by means of the gear changeover switch 212, thereby causing a change in the rotation direction of the drive gear 222.

In some examples, the control component 21 includes at least one of a buzzer 28, an antenna 250 and a remote control, and a trigger switch 27.

As shown in FIG. 3, in the case where the control component 21 includes the buzzer 28, the buzzer 28 may be a waterproof buzzer, and the buzzer 28 is disposed outside the box 1102 and electrically connected to the aforementioned control module 213. When the modular lifting apparatus fails during operation on the guide body 30, the buzzer 28 makes an abnormal sound to give an alert.

As shown in FIG. 4, in the case where the control component 21 includes the antenna 250 and the remote control, the antenna 250 is mounted on the box 1102 and electrically connected to the aforementioned control module 213. In this way, a worker may send a control command to the antenna 250 by means of the remote control to achieve remote control over the modular lifting apparatus, and the control operation is simple and convenient. The remote control is not specifically illustrated in FIG. 4.

After the remote control transmits a radio frequency signal, the radio frequency signal is transmitted in a wireless manner and is received by the antenna 250 for decoding, and the decoded electrical signal directly drives a gear motor, a control switch, and other devices to achieve predetermined functions. In addition, in the case where the control component 21 includes the trigger switch 27, the trigger switch 27 is mounted on the box 1102 and electrically connected to the aforementioned control module 213. The trigger switch 27 may be a contact or non-contact trigger switch such as a mechanical travel switch, a proximity switch, or a mirror-reflective photoelectric switch. The trigger switch 27 in this embodiment is the mirror-reflective photoelectric switch, and the position where the trigger switch 27 is disposed is shown in FIG. 3.

During ascending or descending of the modular lifting apparatus, the trigger switch 27 is used for cooperating with an external trigger device. The trigger switch 27 may send a switching quantity signal to the control module 213 after being triggered by the trigger device, and the control module 213 controls an operation state of the rotary drive member 221 according to the switching quantity signal. For example, the trigger switch 27 may include a first trigger switch, a second trigger switch, and a third trigger switch. The first trigger switch cooperates with an upper trigger block disposed close to an upper end of the guide body 30, so that the modular lifting apparatus is controlled to stop moving upward when the first trigger switch is triggered by the upper trigger block. The second trigger switch cooperates with a lower trigger block disposed close to a lower end of the guide body 30, so that the modular lifting apparatus is controlled to stop moving downward when the second trigger switch is triggered by the lower trigger block. The third trigger switch cooperates with a deceleration trigger block disposed close to an end portion of the guide body 30, so that the modular lifting apparatus is controlled to decelerate when the third trigger switch is triggered by the deceleration trigger block.

As shown in FIG. 1 and FIG. 2, the vehicle body assembly 10 in the embodiment of the present application further includes the handrail component 23, and the handrail component 23 is removably connected to the vehicle body 11.

Specifically, the handrail component 23 includes a first handle 231 and a second handle 232, both of which may be fixedly mounted on the top of the box 1102 by welding or bolting.

At the same time, the first handle 231 and the second handle 232 are spaced apart from each other and are disposed side by side. The first handle 231 and the second handle 232 are used for supporting arms of a worker standing on the pedal component 12, where the first handle 231 may correspond to the left hand of the worker, and the second handle 232 may correspond to the right hand of the worker.

As shown in FIG. 4, a laterally disposed handrail bar 234 is further movably connected between the first handle 231 and the second handle 232, and the handrail bar 234 may be moved to adapt to workers of different heights for holding, so that the applicability of the present application is improved.

In addition, when the box 1102 needs to be moved, a force may be conveniently applied to the box 1102 by means of the handrail bar 234, and with the cooperation of the casters 26 at the bottom of the box 1102, the worker may conveniently pull the box 1102 to move on the ground by holding the handrail bar 234.

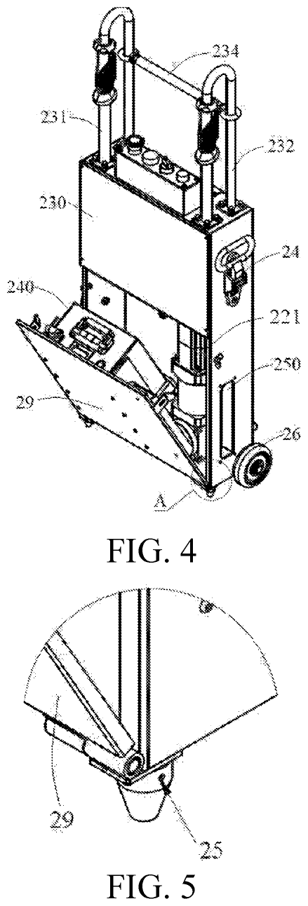

As shown in FIG. 4 and FIG. 5, the box 1102 in this embodiment of the present application is provided with an opening, and a drive cover 29 and a control cover 230 are disposed on the opening. The drive cover 29 and the control cover 230 are each removably connected to the box 1102, which facilitates overhauling and maintenance of the drive component 22 and the control component 21 within the box 1102.

As shown in FIG. 4 and FIG. 5, the drive cover 29 may be movably connected to the box 1102 by means of rotating members, and the rotating members may be rotating shafts, so that the drive cover 29 may be opened by a certain angle with respect to the box 1102, for example, by 30° or 45°, and then the worker may maintain or replace components within the box 1102.

As shown in FIG. 4, the drive control assembly 20 in the embodiment of the present application further includes a power supply module 240, and the control component 21 and the drive component 22 are each electrically connected to the power supply module 240.

In some examples, the power supply module 240 may be a rechargeable battery or a switching power supply. When the power supply module 240 is a rechargeable battery, the drive component 22, and even the entire modular lifting apparatus, may be powered by the rechargeable battery, so that the modular lifting apparatus may be free of accompanying cables, thereby avoiding redundancy caused by accompanying accessories.

At the same time, the rechargeable battery has a low battery protection function. For example, the rechargeable battery is provided with a power sensor, so that during upward movement of the modular lifting apparatus, when the power of the rechargeable battery is lower than a set value, the modular lifting apparatus may only operate downward, not upward, to ensure the operation safety of the modular lifting apparatus.

As shown in FIG. 4, the power supply module 240 may be conveniently pulled out of the box 1102 by opening the drive cover 29, so that the power supply module 240 is conveniently replaced or charged. In some embodiments of the present application, the power supply module 240 may be charged by providing a charging port on the box 1102 and connecting an external power supply to the charging port, instead of taking out the power supply module 240.

As shown in FIG. 6 and FIG. 7, in order to facilitate the installation of the box 1102, the base plate 1101 in the embodiment of the present application is provided with a mounting platform 1103, the mounting platform 1103 is perpendicular to a surface of the base plate 1101, and the box 1102 is removably connected to the mounting platform 1103.

As shown in FIG. 9, in this embodiment, the box 1102 is mounted on the base plate 1101 by means of fasteners 114 while the box 1102 is mounted on the mounting platform 1103. The fasteners 114 may be locking bolts well known in the art. Of course, the fasteners 114 may also be other connectors that enable removable connection of the box 1102 to the base plate 1101.

As shown in FIG. 5 and FIG. 6, in order to achieve the removable connection between the box 1102 and the mounting platform 1103, positioning pins 25 are provided on one side face of the box 1102 facing the mounting platform 1103, positioning holes 1111 are provided on one side face of the mounting platform 1103 facing the box 1102, and the positioning pins 25 fit the positioning holes 1111. The positioning pins 25 are disposed at the bottom of the box 1102, and a plurality of positioning pins 25 and a plurality of positioning holes 1111 are provided in a one-to-one correspondence manner.

As shown in FIG. 2 and FIG. 3, based on the cooperation between the positioning pins 25 and the positioning holes 1111, the modular lifting apparatus may be pre-positioned prior to installation, and then the box 1102 is fixed to the base plate 1101 by means of the fasteners 114.

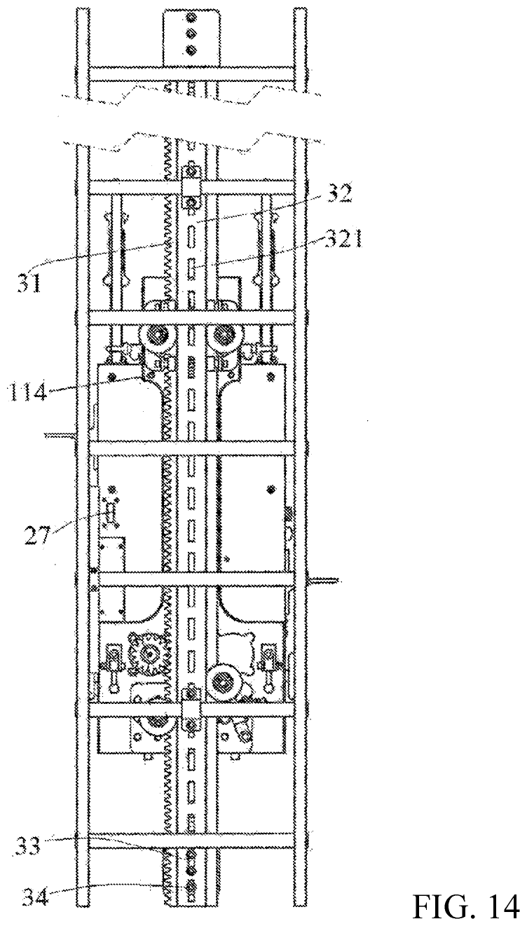

As shown in FIG. 3, FIG. 7, and FIG. 14, since first mounting holes 141 on the box 1102 correspond to first mounting holes 142 on the base plate 1101 after the positioning pins 25 are inserted into the positioning holes 1111, the box 1102 may be fixed to the base plate 1101 by means of the fasteners 114 passing through both the first mounting holes 141 and the second mounting holes 142, thus skipping a mounting step of alignment of two mounting holes. Thus, the installation efficiency may be effectively improved, and the installation precision may be ensured.

As shown in FIG. 6, the pedal component 12 in the embodiment of the present application includes a stepping portion 121 and a mounting portion 122, the stepping portion 121 is a pedal, and the pedal may be a pedal structure in a fixed form or a foldable pedal structure.

The mounting portion 122 is used for mounting of the stepping portion 121 on the base plate 1101, so the specific structure of the mounting portion 122 is not limited, and may be changed adaptively according to the structural form of the pedal.

For example, in this embodiment, the stepping portion 121 includes two pedals, tail ends of the pedals are connected to the mounting portion 122 by means of pins, the mounting portion 122 may be a pin holder, and the mounting portion 122 is fixedly mounted on a position, close to the lower end, of the base plate 1101.

As shown in FIG. 7, the auxiliary guide component 13 in this embodiment of the present application is mounted at positions, close to two ends, of the base plate 1101 for providing a guiding effect for the operation of the modular lifting apparatus.

Further, the auxiliary guide component 13 includes guide wheels 131, and at least one group of guide wheels 131 are provided. The guide wheels 131 act as a guide during ascending or descending of the modular lifting apparatus along the guide body 30. At the same time, the guide wheels 131 act as driven wheels and operate on the guide body 30 along with the drive gear 222 of the drive component 22 to synchronously drive the vehicle body 11 to operate relative to the guide body 30.

When a plurality of groups of guide wheels 131 are provided, the plurality of groups of guide wheels 131 may be sequentially arranged along the extension direction of the guide body 30. The guide wheels 131 may be disposed on positions close to the upper and lower ends of the vehicle body 11, so that the vehicle body 11 is gripped tightly on the guide body 30 by means of the guide wheels 131 during operation, thereby ensuring the stability of the operation of the vehicle body 11 relative to the guide body 30.

As shown in FIG. 7, the auxiliary guide component 13 in the embodiment of the present application further includes a bias guide wheel 132, the bias guide wheel 132 is located on the vehicle body 11 and opposite to the drive gear 222. The bias guide wheel 132 is used for constraining a relative positional relationship between the drive gear 222 and the guide body 30 to ensure that the drive gear 222 has a stable engagement size.

On the basis of the cooperation of the drive gear 222 and the bias guide wheel 132, the vehicle body 11 may be stabilized on the guide body 30. When the drive gear 222 rotates, the bias guide wheel 132 slides against an outer side face of the guide body 30, so that the drive gear 222 and the guide body 30 are always kept in an engaged state.

As shown in FIG. 3 and FIG. 7, the bias guide wheel 132 is mounted on the vehicle body 11 by means of an adjusting member 133, and the adjusting member 133 may make the bias guide wheel 132 move close to or away from the guide body 30. In this way, in practical application, depending on the width of the guide body 30, the engagement size of the drive gear 222 and a rack structure on the guide body 30 may be adaptively adjusted by means of the bias guide wheel 132, so as to ensure that the drive gear 222 and the rack structure on the guide body 30 reach a better engaged state.

In other words, the mounting distance between the drive gear 222 and the bias guide wheel 132 may be adjusted to adapt to guide bodies 30 of different sizes, so that the vehicle body 11 may be produced modularly, and one type of vehicle bodies 11 are produced to adapt to different types of guide bodies 30, which in turn saves the production cost.

The adjusting member 133 includes a telescopic spring through which the bias guide wheel 132 is mounted on the base plate 1101 of the vehicle body 11. When the telescopic spring is in a state of full extension, a center distance between the bias guide wheel 132 and the drive gear 222, i.e., the width of the adapted guide body 30, is minimal. When the width of the guide body 30 is increased, the bias guide wheel 132 squeezes the telescopic spring to compress and deform, which is equivalent to increasing the center spacing between the bias guide wheel 132 and the drive gear 222.

As shown in FIG. 7, the auxiliary guide component 13 in the embodiment of the present application further includes a guide hook wheel 134, and the guide hook wheel 134 is fixedly mounted on the base plate 1101 of the vehicle body 11. During the operation of the modular lifting apparatus along the guide body 30, the guide hook wheel 134 may be in sliding and/or rolling contact with the surface of the guide body 30 to further ensure the stability of the connection of the vehicle body 11 on the guide body 30.

Specifically, the guide hook wheel 134 includes a wheel body and a support (not labeled in the figure) for mounting the wheel body, the support is fixedly mounted on the base plate 1101 of the vehicle body 11, and the guide hook wheel 134 is rotationally mounted on the support by means of a bearing. When the vehicle body 11 ascends or descends on the guide body 30, the guide hook wheel 134 may rotate around the support and be in sliding and/or rolling contact with the surface of the guide body 30.

In addition, the number of the guide hook wheels 134 is not specifically limited, and may be set according to the height of the vehicle body 11. For example, when the height of the vehicle body 11 is increased, the number of the guide hook wheels 134 is increased accordingly.

As shown in FIG. 7, the auxiliary guide component 13 in the embodiment of the present application further includes a supporting wheel 115, the supporting wheel 115 and the pedal component 12 are oppositely disposed on the vehicle body 11, and the supporting wheel 115 is in rolling connection to the guide body 30.

When a worker stands on the pedal component 12, the gravity force on the pedal component 12 may be transferred to the guide body 30 via the supporting wheel 115 because the pedal component 12 is usually disposed at the lower end of the vehicle body 11. In this way, the supporting wheel 115 in this embodiment is used for balancing the load of the pedal component 12, and on the basis of the good support provided by the supporting wheel 115 to the pedal component 12, the situation that when the pedal component 12 carries too much weight, friction is caused between the base plate 1101 of the vehicle body 11 and the guide body 30, which in turn affects the operation of the vehicle body 11 on the guide body 30 may be prevented.

It should be noted herein that in order to ensure the reliability of the supporting wheel 115 in providing support to the pedal component 12, the supporting wheel 115 in this embodiment is located at the middle position of the mounting portion 122, the supporting wheel 115 may be rotationally connected to a guide wheel holder (not labeled in the figure) by means of a bearing, and the guide wheel holder may be fixedly mounted on the base plate 1101 of the vehicle body 11 by means of bolts.

Based on the solutions of the above embodiment, in practical application, in this embodiment, the drive control assembly 20 may be firstly integrated on the box 1102, and then the box 1102 is removably connected to the base plate 1101 by means of the fasteners 114. This mounting method may not only achieve rapid disassembly and installation of the modular lifting apparatus, but also achieve modular production of the drive control assembly 20 and the box 1102. Moreover, the box 1102 integrated with the drive control assembly 20 may be configured on a plurality of base plates 1101 of the same model, so that the production cost and the procurement cost of users are reduced.

In some embodiments of the present application, referring to FIG. 8, on the basis of the above embodiment, and different from the above embodiment, the structural form of the handrail component 23 may be linear, a platform trigger structure 233 is disposed on any one of the handles of the handrail component 23, the platform trigger structure 233 is connected to the mechanical trigger switch, and the mechanical trigger switch is connected to the control component 21 in the above embodiment.

The platform trigger structure 233 is fixedly connected to at least one of the handles of the handrail component 23 by means of a pin. When the modular lifting apparatus operates upward and encounters an obstacle, the platform trigger structure 233 may trigger the mechanical trigger switch to switch an on-off state, and the control component 21, upon receiving the switching quantity signal of the mechanical trigger switch, controls the modular lifting apparatus to stop operating, so as to prevent the modular lifting apparatus from being damaged by an impact.

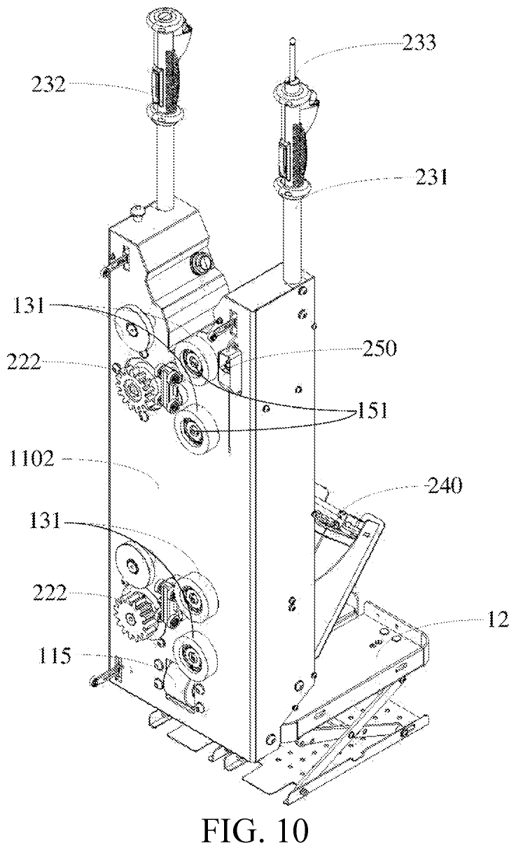

In some embodiments of the present application, referring to FIG. 9 and FIG. 10, on the basis of some of the above embodiments, and different from the above embodiments, the vehicle body 11 in the embodiment of the present application includes the box 1102, the pedal component 12 and the box 1102 are removably connected, the drive control assembly 20 is mounted within the box 1102, and a portion of the drive control assembly 20 extends out of the box 1102 and cooperates with the guide body 30.

It is to be understood that in this embodiment, the base plate 1101 and the box 1102 in Embodiment 1 are integrated to form the vehicle body 11 having a box structure, so that in this embodiment, the pedal component 12 and the drive control assembly 20 are jointly disposed in the vehicle body 11 having the box structure.

In order to ensure the structural strength of the box 1102 in this embodiment, the box 1102 includes a structural frame 1121 and box plates 1122. The box plates 1122 are mounted on the structural frame 1121, and a plurality of box plates 1122 are provided, so that the structural frame 1121 and the plurality of box plates 1122 form the closed box 1102.

In this way, by integrating the pedal component 12 and the drive control assembly 20 in the same box 1102, the compactness of the overall structure of the modular lifting apparatus is ensured, and the occupied space is reduced.

As shown in FIG. 9 and FIG. 10, the drive control assembly 20 in this embodiment further includes a power supply module 240. The control component 21 further includes a control module 213, and the control switch, the buzzer 28, the antenna 250, and the trigger switch 27 in the above embodiments are each connected to the control module 213. The power supply module 240 is electrically connected to the control module 213 and the drive component 22 respectively, so as to provide a working power supply for the operation of the control module 213 and the drive component 22.

The control module 213 may include at least one of an inverter, a PLC, a single-chip microcontroller, and a microprocessor known in the art.

Further, the vehicle body 11 in the embodiment of the present application is provided with a first chamber 101 and a second chamber 102; the power supply module 240 is disposed in the first chamber 101; and at least a portion of the control component 21 and at least a portion of the drive component 22 are disposed in the second chamber 102.

In practical application, a first spacer 1131 may be disposed within the box 1102 to divide the box 1102 into the first chamber 101 and the second chamber 102. The box 1102 is provided with an opening corresponding to the first chamber 101, and the drive cover 29 in the above embodiment is movably connected to the opening of the box 1102 by means of a rotating member. Moreover, the drive cover 29 may be constructed as a box structure, so that the power supply module 240 is mounted in an accommodating space formed by the drive cover 29.

In this way, during operation of the modular lifting apparatus, the drive cover 29 is located in the opening, and an outer surface of the drive cover 29 is flush with a panel of the box 1102. When the power supply module 240 needs to be overhauled, the drive cover 29 may be controlled to be opened at a certain angle relative to the box 1102, so that the power supply module 240 is conveniently taken out of the box 1102.

At the same time, the control module 213 in this embodiment of the present application may adopt a frequency converter, the drive component 22 may include a gear motor and the drive gear 222, the frequency converter and the gear motor are both mounted in the second chamber 102, an output end of the gear motor passes through the box 1102 in turn and is connected to the drive gear 222, and the drive gear 222 is engaged with the guide body 30.

In addition, the pedal component 12 in the embodiment of the present application is disposed at the bottom of the box 1102, the pedal component 12 includes a stepping portion 121 and a mounting portion 122, one end of the stepping portion 121 is rotationally connected to the mounting portion 122, and the mounting portion 122 is removably connected to the bottom of the box 1102.

It should be noted herein that the box 1102 in this embodiment may also be provided with the auxiliary guide components 13 such as the guide wheel 131, the bias guide wheel 132, the guide hook wheels 134, and the supporting wheel 115 in the above embodiment, which will not be repeated herein.

Further, as shown in FIG. 10, the auxiliary guide component in this embodiment includes at least one group of guide wheels 131, each group of guide wheels 131 include a plurality of guide wheels and may be divided into a first part of guide wheels and a second part of guide wheels, and the first part of guide wheels and the second part of guide wheels are disposed on opposite sides of the guide body 30 respectively and are in rolling contact with the surface of the guide body 30. The guide wheels 131 are disposed by means of eccentric shafts 151, and one ends of the eccentric shafts 151 away from the guide wheels 131 are connected to the box 1102.

It is to be understood that in this embodiment, by adjusting the assembly angle of the guide wheels 131 relative to the eccentric shafts 151, the center spacing between the first part of guide wheels and the second part of guide wheels may be adjusted, so that each group of guide wheels 131 are suitable for guide bodies 30 of different widths.

In this way, in this embodiment, by providing the guide wheels 131, the modular lifting apparatus may operate up and down along a side wall of the guide body, which provides support for ascending or descending of the modular lifting apparatus; moreover, by adjusting the positional relationship between the guide wheels 131 and the guide body 30, the situation that as the guide wheels 131 and the guide body 30 fail to be tightly attached, the modular lifting apparatus shakes during operation may be prevented.

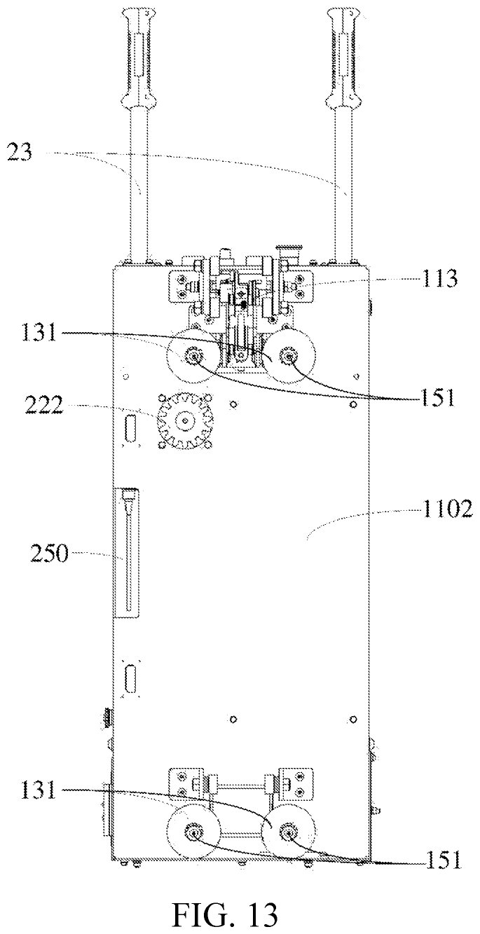

In some embodiments of the present application, referring to FIG. 11, FIG. 12, and FIG. 13, on the basis of the above embodiments, and different from the above embodiments, in the height direction of the box 1102, the first chamber 101 is disposed on the lower side of the second chamber 102, and the pedal component 12 is disposed between the first chamber 101 and the second chamber 102.

At the same time, a second spacer 1132 is disposed in the second chamber 102 in this embodiment, and the second spacer 1132 divides the second chamber 102 into a first compartment and a second compartment. The first compartment and the second compartment are arranged in a width direction of the box 1102. The control module 213 in the above embodiment is disposed in the first compartment, and at least a portion of the drive component 22 is disposed in the second compartment.

In some embodiments of the present application, referring to FIG. 7, FIG. 9, and FIG. 12, on the basis of any of the above embodiments, and different from each of the above embodiments, the vehicle body 11 further includes a stall protection device 113, and the stall protection device 113 is located on the same side as the auxiliary guide component 13. When the vehicle body 11 ascends or descends along the guide body 30, the stall protection device 113 may restrict the vehicle body 11 to the guide body 30 in the case where the vehicle body 11 stalls and falls down, so as to ensure the operation safety of the modular lifting apparatus.

Further, the stall protection device 113 is fixedly connected to the vehicle body 11, either by bolts or screws.

The stall protection device 113 may be a centrifugal flinging block structure, i.e. including a centrifugal flinging block, a spring and a speed measuring wheel. The centrifugal flinging block cooperates with the guide body 30 to achieve limitation. The speed measuring wheel is used for measuring the falling speed of the vehicle body 11.

Under normal speed conditions, the stall protection device 113 is in a closed state, that is, the centrifugal flinging block is stored in the stall protection device 113. When the vehicle body 11 operates downward along the guide body 30, the speed measuring wheel rotates along the guide body 30 and drives the centrifugal flinging block to rotate, and when the modular lifting apparatus falls down in a stalled state, that is, the descending speed of the modular lifting apparatus is more than a set speed threshold, the centrifugal flinging block overcomes the tension of a spring to be flung outward, to achieve instant locking on the guide body 30.

In addition, the stall protection device 113 may also use a mechanical locking member disclosed in Publication No.: CN111807188A, which may selectively make the lifting apparatus be quickly locked onto the guide body 30 under any circumstances, including sudden locking of the lifting apparatus during upward movement.

In some embodiments of the present application, referring to FIG. 2, auxiliary stepping members 24 are disposed on two sides of the box 1102 corresponding to the vehicle body 11. By means of the auxiliary stepping members 24, it may be ensured that in an emergency situation or when the modular lifting apparatus stops on the guide body 30 and is unable to operate, the worker may escape upward or downward by three-point contact type movement, to avoid inconvenience during escape as the modular lifting apparatus is located between the worker and the ladder, thereby ensuring the safety of the worker.

The auxiliary stepping member 24 may rotate around points where the auxiliary stepping members are connected to the vehicle body 11, so that when in use, the auxiliary stepping members 24 are unfolded; and when not in use, the auxiliary stepping members 24 are folded to avoid affecting ascending or descending of the vehicle body 11.

Specifically, the auxiliary stepping member 24 includes an auxiliary plate 241 and a mounting seat 242. The auxiliary plate 241 and the mounting seat 242 are movably connected, so that the auxiliary plate 241 may be rotated relative to the mounting seat 242 to be folded or unfolded for use, or that the auxiliary plate 241 may be freely switched between the state of being folded and the state of being unfolded for use.

In some embodiments of the present application, referring to both FIG. 1 and FIG. 14, this embodiment provides a lifting system. The lifting system includes a guide body 30 and the modular lifting apparatus according to any one of the above embodiments, the guide body 30 being attached to a surface of a building or a surface of a tower.

As shown in FIG. 14, the guide body 30 includes a base guide rail 31 and a fall prevention guide rail 32, the base guide rail 31 is provided with an accommodating groove along the axial direction, and the fall prevention guide rail 32 may be embedded in the accommodating groove, and together with the base guide rail 31, form the guide body 30.

The base guide rail 31 is mainly used for carrying, and the fall prevention guide rail 32 is mainly used for preventing falling. As the two guide rails are combined in a nested manner, the main load of the modular lifting apparatus may be borne, moreover, the vehicle body 11 may be locked for fall prevention in cooperation with the stall protection device 113, and the strength and rigidity of the guide body 30 may also be enhanced.

A drive portion and a positioning portion are provided on two sides of the groove opening of the accommodating groove, respectively, and extend outward from an edge of the groove opening (i.e., in a direction away from the groove opening), and a rack is provided on the drive portion for cooperating with a drive gear 222 to achieve power output.

The fall prevention guide rail 32 is provided with fall prevention holes 321, and the fall prevention holes 321 are locking slot holes, and are designed for the stall protection device 113 to be locked on the guide body 30 in an emergency situation.

Referring to FIG. 14, a trigger device is mounted on the guide body 30, the trigger device includes a trigger limiting mechanism 33 and a mechanical limiting mechanism 34 disposed at both ends of the guide body 30, and the trigger limiting mechanism 33 includes an upper trigger block and a lower trigger block. At the same time, a trigger switch 27 is mounted on a surface of a box 1102. During upward movement of the modular lifting apparatus, when the trigger switch 27 detects the upper trigger block, the trigger switch 27 sends a signal to the control module 213 to trigger a gear motor to stop rotating, so that the modular lifting apparatus stops moving upward; similarly, during downward movement of the modular lifting apparatus, when the trigger switch 27 detects the lower trigger block, the trigger switch 27 sends a signal to the control module 213 to trigger the gear motor to stop rotating, so that the modular lifting apparatus stops moving downward, thereby ensuring the operation safety of the modular lifting apparatus.

The mechanical limiting mechanism 34 further includes an upper limiting block and a lower limiting block. When trigger control formed by the trigger switch 27 and the trigger limiting mechanism 33 fails, the modular lifting apparatus mechanically collides with the upper limiting block and the lower limiting block during operation and is forced to stop operating, so that the modular lifting apparatus is prevented from sliding out of the guide body 30 to result in a major accident, thereby improving the operation safety of the apparatus.

In the description of this specification, reference to the description of the terms “one embodiment”, “some embodiments”, “exemplary embodiments”, “example”, “specific example”, or “some examples”, etc. means that the specific features, structures, materials, or characteristics described in connection with the embodiment or example are included in at least one embodiment or example of the present application. In this specification, schematic representations of the above terms do not necessarily refer to the same embodiments or examples. Furthermore, the specific features, structures, materials, or characteristics described may be combined in any suitable manner according to any one or more embodiments or examples.

While examples of the present application have been shown and described, it may be understood by a person skilled in the art that various changes, modifications, substitutions and alterations may be made to these embodiments without departing from the principles and purposes of the present application, the scope of which is defined by the appended claims and their equivalents.

1. A modular lifting apparatus, comprising:
a vehicle body assembly, comprising a vehicle body and a pedal component, the pedal component being connected to the vehicle body; and
a drive control assembly, disposed on the vehicle body and comprising a control component, a drive component and an auxiliary guide component, the control component being connected to the drive component,
wherein the drive component and the auxiliary guide component are used for cooperating with a guide body to allow the vehicle body to move in an extension direction of the guide body.

2. The modular lifting apparatus according to claim 1, wherein the vehicle body comprises a base plate and a box, the pedal component and the box are each removably connected to the base plate, the drive control assembly is mounted in the box, and a portion of the drive control assembly extends out of the box and cooperates with the guide body.

3. The modular lifting apparatus according to claim 2, wherein the drive component comprises a rotary drive member and a drive gear, the rotary drive member is disposed within the box, an output end of the rotary drive member penetrates through the box and the base plate in sequence and is connected to the drive gear, and the drive gear is engaged with the guide body.

4. The modular lifting apparatus according to claim 2, wherein the base plate is provided with a mounting platform, the mounting platform is perpendicular to a surface of the base plate, and the box is removably connected to the mounting platform.

5. The modular lifting apparatus according to claim 4, wherein positioning pins are provided on one side face of the box facing the mounting platform, positioning holes are provided in one side of the mounting platform facing the box, and the positioning pins fit the positioning holes.

6. The modular lifting apparatus according to claim 4, wherein casters are disposed at a bottom of the box.

7. The modular lifting apparatus according to claim 1, wherein the vehicle body comprises a box, the pedal component and the box are removably connected, the drive control assembly is mounted in the box, and a portion of the drive control assembly extends out of the box and cooperates with the guide body.

8. The modular lifting apparatus according to claim 1, wherein the drive control assembly further comprises: a power supply module; the control component and the drive component are each electrically connected to the power supply module; and the power supply module adopts a rechargeable battery or a switching power supply.

9. The modular lifting apparatus according to claim 1, wherein the vehicle body assembly further comprises a handrail component, the handrail component is removably connected to the vehicle body, the handrail component comprises a first handle and a second handle, and a handrail bar is movably connected between the first handle and the second handle.

10. The modular lifting apparatus according to claim 1, wherein the pedal component comprises a stepping portion and a mounting portion, and the stepping portion is connected to the vehicle body by means of the mounting portion.

11. The modular lifting apparatus according to claim 1, wherein the auxiliary guide component comprises at least one set of guide wheels; and in a case where the modular lifting apparatus moves along the guide body, the guide wheels are in contact with a surface of the guide body and abut against a side face of the guide body.

12. The modular lifting apparatus according to claim 11, wherein the guide wheels are provided by means of an eccentric shaft.

13. The modular lifting apparatus according to claim 1, wherein the auxiliary guide component further comprises a bias guide wheel, and the bias guide wheel is disposed on the vehicle body by means of an adjusting member for rotating in conjunction with a drive gear of the drive component.

14. The modular lifting apparatus according to claim 1, wherein the auxiliary guide component further comprises guide hook wheels, the guide hook wheels are provided in pairs, and in a case where the modular lifting apparatus moves along the guide body, the guide hook wheels are located on two sides of the guide body.

15. The modular lifting apparatus according to claim 1, wherein the auxiliary guide component further comprises a supporting wheel, the supporting wheel and the pedal component are oppositely disposed on the vehicle body, and the supporting wheel is in rolling connection with the guide body.

16. The modular lifting apparatus according to claim 1, wherein the vehicle body is provided with a stall protection device, and the stall protection device is located on the same side as the auxiliary guide component.

17. The modular lifting apparatus according to claim 1, wherein auxiliary stepping members are movably connected to two sides of the vehicle body, so that the auxiliary stepping members are switched between a folded state and an unfolded state.

18. The modular lifting apparatus according to claim 1, wherein the control component comprises a control switch; and the control switch is used for controlling upward movement, downward movement and decelerated operation of the modular lifting apparatus, as well as for emergency stop operation and switching a control mode of the modular lifting apparatus.

19. The modular lifting apparatus according to claim 1, wherein the control component comprises at least one of a buzzer, an antenna, and a trigger switch.

20. A lifting system, comprising a guide body and the modular lifting apparatus according to claim 1, the guide body being attached to a surface of a building or a surface of a tower.
